(19) United States
(12) Patent Application Publication
(10) Pub. No.: US 2008/0203691 A1
(43) Pub. Date: Aug. 28, 2008

(54) Scooter Having An Anti-Skid Brake Device

(76) Inventor: Jung-Yu Hsu, Tainan City (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 11/678,729

(22) Filed: Feb. 26, 2007

(51) Int. Cl. B62M 1/00

(52) U.S. Cl. 280/87.041

(57) ABSTRACT

A scooter having an anti-skid brake device includes a rear wheel hood. The rear wheel hood is provided with a brake section on the inner surface, an anti-skid section on the outer surface and a torsion spring to enhance the brake effect as well as to prevent skid when stepping on the rear wheel hood to stop the movement.

### BACKGROUND OF THE INVENTION

1. Field of the Invention

The present invention relates to a scooter having an anti-skid brake device, in particular to a rear wheel hood provided with a brake section on an inner surface, an anti-skid section on an outer surface, and a torsion spring to enhance the brake effect.

2. Description of the Prior Art

Scooter has becoming a great sports and transportation in many cities that have a serious traffic congestion problem. Such as school, many people use a scooter to travel between quarters and classroom to avoid the traffic and parking problem.

Most scooters have a brake system at a rear wheel, such as U.S. Pat. No. 6,139,035, “Brake Device for a Skate Cart”, which includes a rear wheel hood pivotally connected to the frame of the skate cart and the rear wheel hood has a curved engaging inside so as to contact the rear wheel of the skate cart and stop the skate cart. A resilient member has one end thereof connected to the rear wheel hood and the other end of the resilient member is connected to the frame. When stepping on the rear wheel hood, the rear wheel hood is pivoted to contact the rear wheel and when removing the foot from the rear wheel hood, the rear wheel hood returns by the resilient member.

There are some shortcomings of the prior art:

1. the resilient member requires a fastener to be secured;

2. the rear wheel hood is in a polished arc shape which has less friction, thus the brake effect may not be as expected;

3. the polished surface of the rear wheel hood may cause the foot to slip when stepping on the rear wheel hood.

### SUMMARY OF THE INVENTION

According to the present invention, there is provided a scooter having an anti-skid brake device comprising a rear wheel hood connected to the scooter, a brake section being provided on an inner surface of said rear wheel hood, an anti-skid section being provided on an outer surface of said rear wheel hood, one end of said rear wheel hood being provided with through holes and a torsion spring, a fastener inserting through said through holes and said torsion spring to secure said rear wheel hood to the rear of the scooter.

It is a primary object of the present invention to provide a scooter having an anti-skid brake device, which provides a rear wheel hood formed in one piece and is easy to install.

It is another object of the present invention to provide a scooter having an anti-skid brake device, which is cost-effective in material and in manufacture.

It is a further object of the present invention to provide a scooter having an anti-skid brake device, which can stop the rolling of the scooter in a quick and instant reaction, making the rider safe.

It is still a further object of the present invention to provide a scooter having an anti-skid brake device, which has an anti-skid section to assist the rider to brake the rolling efficiently and accurately.

### BRIEF DESCRIPTION OF DRAWINGS

FIG. 1 is a side view of the present invention;

FIG. 2 is an exploded view of the present invention;

FIG. 3 is a cross-sectional view of the present invention; and

FIG. 4 is a view similar to FIG. 3 in an operating status.

### DETAILED DESCRIPTION OF THE PREFERRED EMBODIMENT

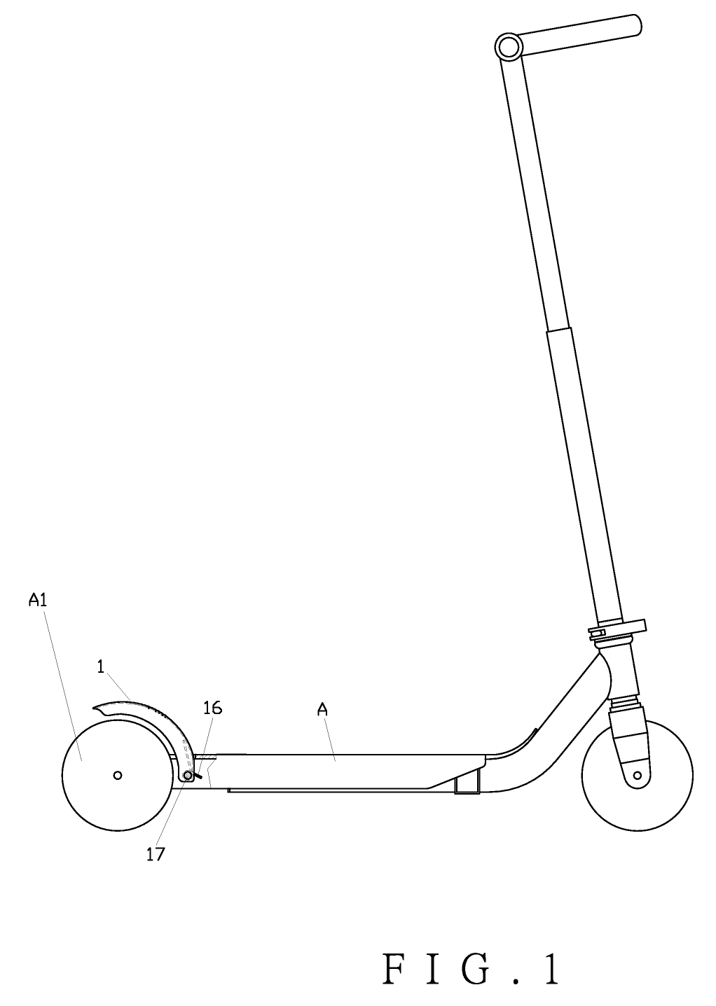

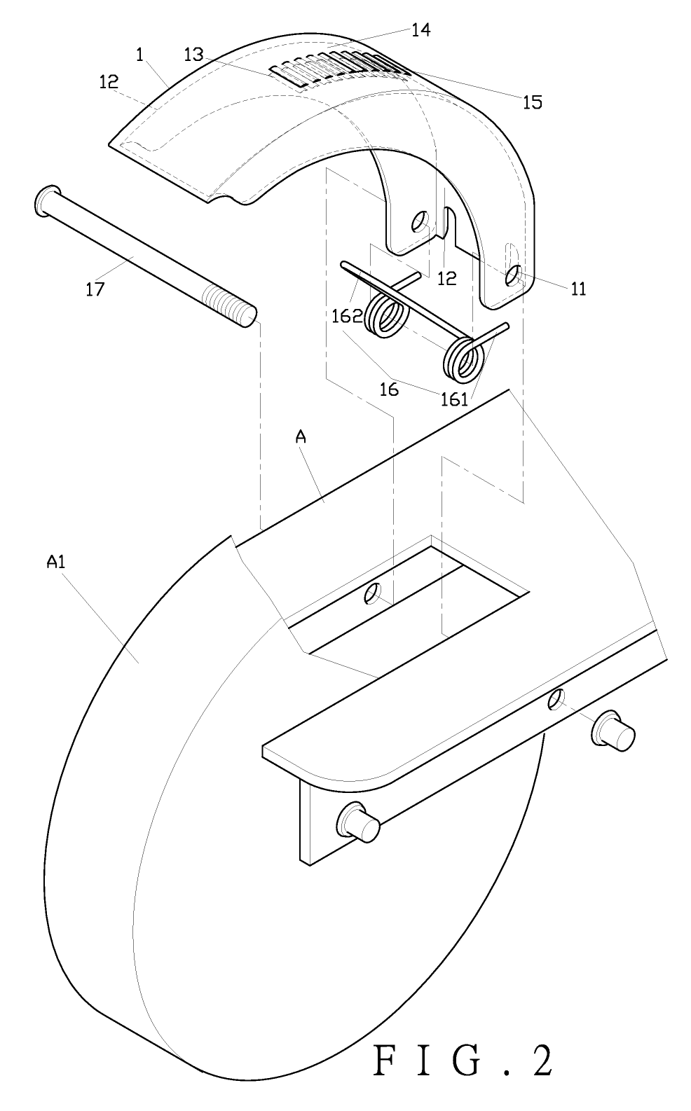

As shown in FIGS. 1, 2 and 3, the present invention comprises a rear wheel hood (1) coupled to a scooter (A). One end of the rear wheel hood (1) is disposed with through holes (11). The rear wheel hood (1) is provided with a brake section (13) on an inner surface (12) of the rear wheel hood (1). The brake section (13) is formed with a series of strips corresponding to a rear wheel (A1). The rear wheel hood (1) is provided with an anti-skid section (15) on an outer surface (14) of the rear wheel hood (1). The anti-skid section (15) is formed with a series of strips. The rear wheel hood (1) is provided with a torsion spring (16) corresponding in position to the through holes (11). A fastener (17) is inserted through the through holes (11) and the torsion spring (16) and secured to the scooter (A). The torsion spring (16) has a first end (161) engaging with the end of the rear wheel hood (1) and a second end (162) engaging with the inner surface (12) of the rear wheel hood (1).

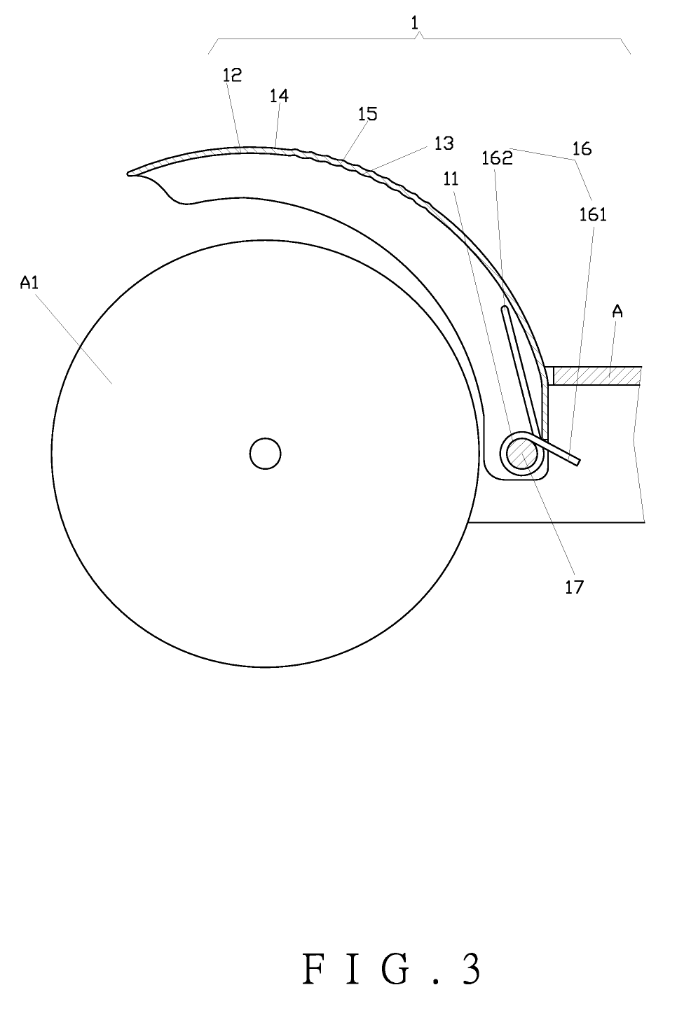

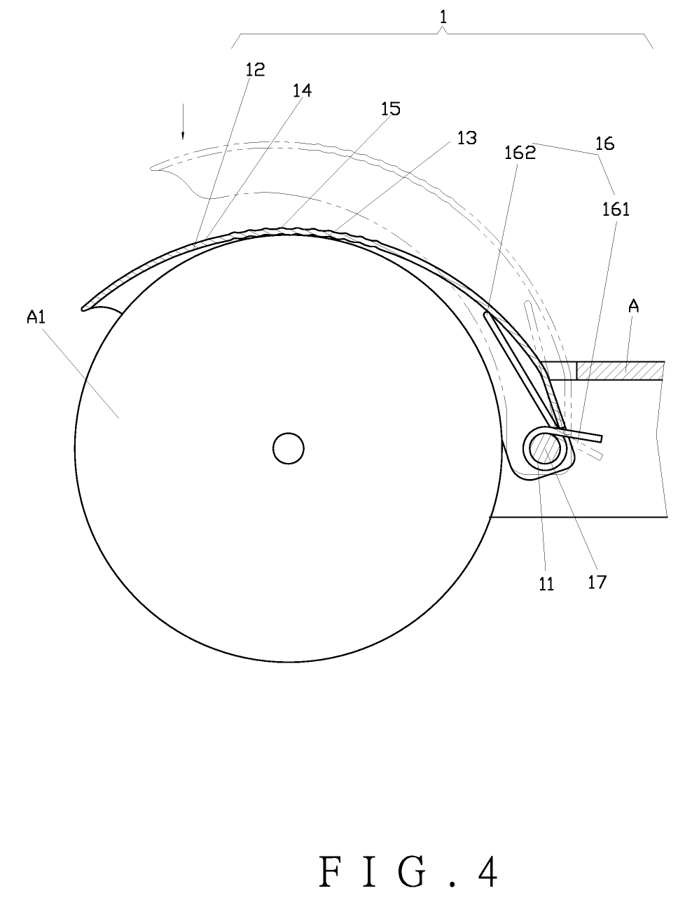

To operate the present invention, as shown in FIG. 4, the rear wheel hood (1) of the scooter (A) remains a distance with respect to the rear wheel (A1) in a constant manner which does not affect rolling of the rear wheel (A1). When the rider steps on the rear wheel hood (1), as shown in FIG. 3, the anti-skid section (15) provided on the outer surface (14) will hold the rider's foot from skidding and the brake section (14) will engage with the rear wheel (A2) to slow down the rolling movement.

When removing the foot from the rear wheel hood (1), the second end (162) of the torsion spring (16) will urge the rear wheel hood (1) to return to its original position, which brings the brake section (13) away from the rear wheel (A1).

What is claimed is:

1. A scooter having an anti-skid brake device, comprising a rear wheel hood connected to the scooter, a brake section being provided on an inner surface of said rear wheel hood, an anti-skid section being provided on an outer surface of said rear wheel hood, one end of said rear wheel hood being provided with through holes and a torsion spring, a fastener inserting through said through holes and said torsion spring to secure said rear wheel hood to the rear of the scooter.

2. The scooter having an anti-skid brake device, as recited in claim 1, wherein said brake section is formed with a series of strips

3. The scooter having an anti-skid brake device, as recited in claim 1, wherein said anti-skid section is formed with a series of strips

4. The scooter having an anti-skid brake device, as recited in claim 1, wherein said brake section and said anti-skid section are formed with a series of same strips.
